(19) United States
(12) Patent Application Publication
(10) Pub. No.: US 2012/0129123 A1
(43) Pub. Date: May 24, 2012

(54) MULTI-COORDINATE ORTHODONTIC IMPLANT POSITIONING DEVICE

(76) Inventor: Yin-Chao YAO, Tashi Town (TW)

(21) Appl. No.: 12/950,252

(22) Filed: Nov. 19, 2010

(51) Int. Cl. A61C 7/00

(52) U.S. Cl. 433/24

(57) ABSTRACT

A multi-coordinate orthodontic implant positioning device includes a measuring reference member having a predetermined thickness and being provided thereon with measuring scales formed of a radiopaque material. The measuring reference member is connected at an edge to a fixing member for fixedly attaching to the patient's teeth. The measuring scales define a coordinate-type positioning structure, which includes at least a main coordinate system and a sub-coordinate system. The main coordinate system divides the positioning structure into a plurality of coordinate blocks, each of which has a main coordinate code readable from the main coordinate system; and the sub-coordinate system is provided in some specified ones of the coordinate blocks. Since the main coordinate system and the sub-coordinate system are two different and independent coordinate systems, the use of them enables primary and more accurate positioning of an implant point to effectively upgrade the efficiency in the orthodontic implant surgery.

### FIELD OF THE INVENTION

The present invention relates to an auxiliary positioning device used in orthodontics, and more particularly to a multi-coordinate orthodontic implant positioning device that provides an accurate measuring reference to enable quick determination in primary diagnosis to ensure accurate positioning of an optimal implant point.

### BACKGROUND OF THE INVENTION

In recent years, implant orthodontics has been quickly and widely employed by orthodontic field for using in clinical orthodontic treatment. By implant orthodontics, it means the implanting of a mini-implant into a patient's alveolar bone to serve as a force application point and provide a stable source of pull for moving a patient's teeth, so as to achieve the best bite occlusion relationship and improved facial aesthetics as well as enhanced effect of orthodontic treatment. When the orthodontic treatment is completed, the mini-implant is removed from the patient's oral cavity. Thus, the mini-implant that is temporarily implanted into the alveolar bone for the purpose of orthodontics is referred to as an orthodontic implant.

The orthodontic implant used in the clinical orthodontic treatment provides a stable source of pull in the process of orthodontic treatment. The orthodontic implant simplifies the biomechanical design for orthodontic treatment and shortens the course and time of orthodontic treatment without the need of patient's cooperation. With the orthodontic implant, some patients that would otherwise require surgery in an operation room can now obtain very good orthodontic treatment effect through simple outpatient surgery at largely reduced medical expense. However, due to physical or anatomical differences among patients, or due to improper implant position, there is possibility the implanted orthodontic implant undesirably injures the patient's tooth roots.

To avoid the problem of improper implant position and to minimize the angular deviation possibly occurred during the implanting of the orthodontic implant, there is developed an orthodontic implant positioning device for use along with the orthodontic implant.

FIG. 1 shows a conventional orthodontic implant positioning device that includes a measuring reference member 91 provided with radiopaque measuring scales and a fixing member 92 connected to an edge of the measuring reference member 91. The orthodontic implant positioning device can be attached to a patient's teeth for marking an implant point for performing the implant surgery and holding an x-ray film holder in place, so as to ensure that the measuring scales are the same each time an x-ray picture is taken and a relative position of the patient's teeth to the x-ray film is unchanged. The orthodontic implant positioning device not only effectively improves the accuracy in implanting the orthodontic implant, but also serves as an auxiliary support to ensure accurate and correct implanting angle of the orthodontic implant. However, the conventional orthodontic implant positioning device still requires improvement in terms of it ability for helping a dentist in reading out the implant position. Since the orthodontic surgery belongs to a microsurgery and the space between two adjacent tooth roots is very small and narrow, the measuring scales provided on the orthodontic implant positioning device are very tiny. In most cases, the distance between two adjacent measuring scales is in the order of 1˜2 mm. While there are counting marks 93 provided on the measuring scales at regular intervals, it is still very inconvenient for the dentist to accurately determine the implant position for the orthodontic implant by counting the lines and rows of the tiny measuring scales.

### SUMMARY OF THE INVENTION

A primary object of the present invention is to provide an orthodontic implant positioning device to enable quick and accurate determining of a point for implanting an orthodontic implant, so as to effectively shorten the time needed to read an x-ray picture and determine the accurate implant point from the orthodontic implant positioning device as well as largely reduce the rate of error in determining the implant point.

To achieve the above and other objects, the present invention provides a multi-coordinate orthodontic implant positioning device for disposing in a patient's oral cavity between two adjacent teeth at a cheek side or a tongue side thereof to serve as a measuring and positioning reference. The device includes a measuring reference member, which on the one hand has a predetermined thickness to possess sufficient strength for serving as a temporary support in the process of implanting an orthodontic implant and, on the other hand, is slim and light enough for disposing at the cheek side or the tongue side space of a patient's teeth. The measuring reference member is provided thereon with a plurality of measuring scales formed of a radiopaque material, and is connected at an edge to a fixing member for fixedly attaching to the patient's teeth. The measuring scales define a coordinate-type positioning structure, which includes at least a main coordinate system and a sub-coordinate system. The main coordinate system divides the positioning structure into a plurality of coordinate blocks, each of which has a main coordinate code readable from the main coordinate system; and the sub-coordinate system is provided in some specified ones of the coordinate blocks, so that more accurate positioning can be achieved in the specified coordinate blocks. The measuring reference member is made of a flexible material, so that it is bendable in the patient's oral cavity.

In a preferred embodiment of the present invention, the main coordinate system is a Cartesian coordinate system, so that the measuring scales define a plurality of rectangular coordinate blocks. A set of first coordinate axis marks and a set of second coordinate axis marks are separately provided at two adjacent edges of the measuring reference member.

In the preferred embodiment, the first coordinate axis marks are located at one edge of the measuring reference member opposite to the edge connected to the fixing member, and the second coordinate axis marks are located at one edge of the measuring reference member adjacent to the edge connected to the fixing member. And, the main coordinate system is preferably a Cartesian coordinate system defining at least 2×2 coordinate blocks.

In another preferred embodiment of the present invention, the first coordinate axis marks and the second coordinate axis marks are different marks selected from laterally symmetrical patterns or symbols. By doing this, there is no risk of taking an x-ray picture with laterally reversed or hardly recognizable coordinate axis marks, no matter how the orthodontic implant positioning device is disposed in the patient's oral cavity.

In a further preferred embodiment of the present invention, the sub-coordinate system divides each of the specified coordinate blocks into a plurality of coordinate cells and provides at least one positioning mark in one of the coordinate cells. The sub-coordinate system is preferably a 3×3 Cartesian coordinate system dividing each of the specified coordinate blocks into nine identical coordinate cells, and the positioning mark is located in a middle one of the nine coordinate cells.

In the present invention, the main coordinate system and the sub-coordinate system are two different and independent coordinate systems for positioning an implant point. The main coordinate system enables primary and quick positioning while the sub-coordinate system independent of the main coordinate system enables more accurate positioning. The present invention maintains the required accuracy in positioning while reduce the rate of error in determining the optimal implant point, and therefore effectively upgrades the efficiency in performing an orthodontic implant surgery.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a conventional orthodontic implant positioning device;

FIG. 2 a perspective view of a multi-coordinate orthodontic implant positioning device according to a preferred embodiment of the present invention;

FIG. 3 is a fragmentary and enlarged view of FIG. 2 for showing some coordinate cells thereof;

FIG. 4A shows nine coordinate cells that are located in the same one coordinate block defined according to the present invention;

FIG. 4B shows nine coordinate cells that are not located in the same one coordinate block defined according to the present invention;

FIG. 5 is a perspective view showing the coordinate cells in one coordinate block divided according to a sub-coordinate system according to another embodiment of the present invention;

FIG. 6 shows the use of the present invention in taking an X-ray picture for measuring inter-teeth distance; and

FIG. 7 shows the use of the x-ray picture taken with the aid of the present invention to determine an optimal implant point.

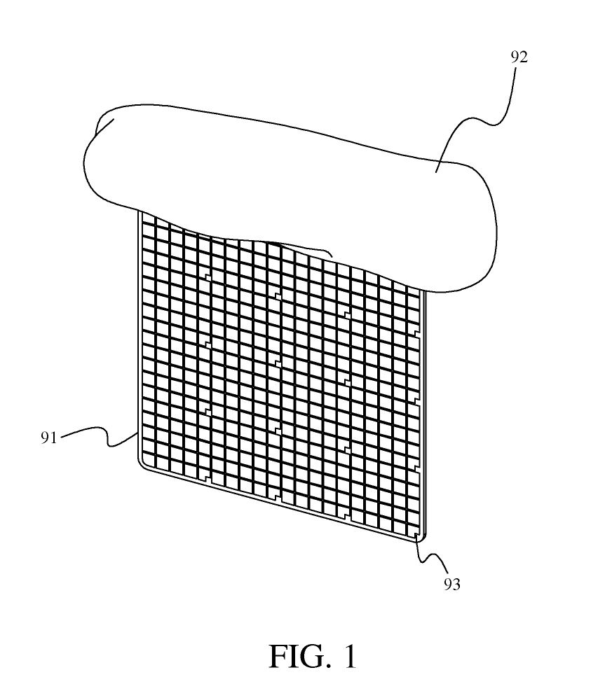

### DETAILED DESCRIPTION OF THE PREFERRED EMBODIMENTS

The present invention will now be described with some preferred embodiments thereof and with reference to the accompanying drawings.

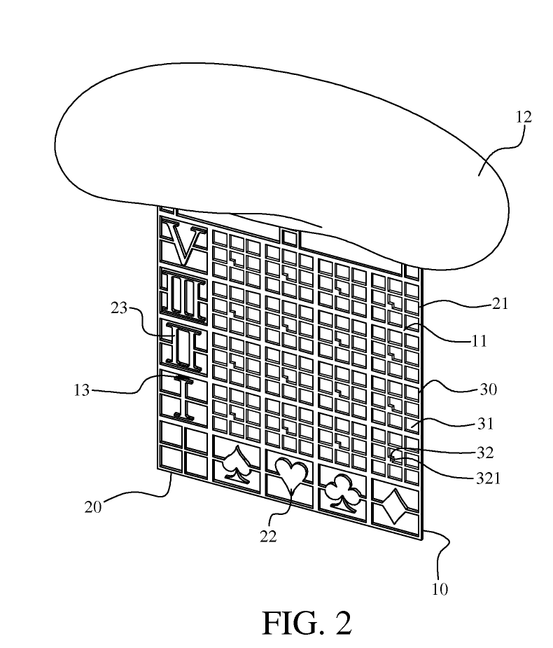

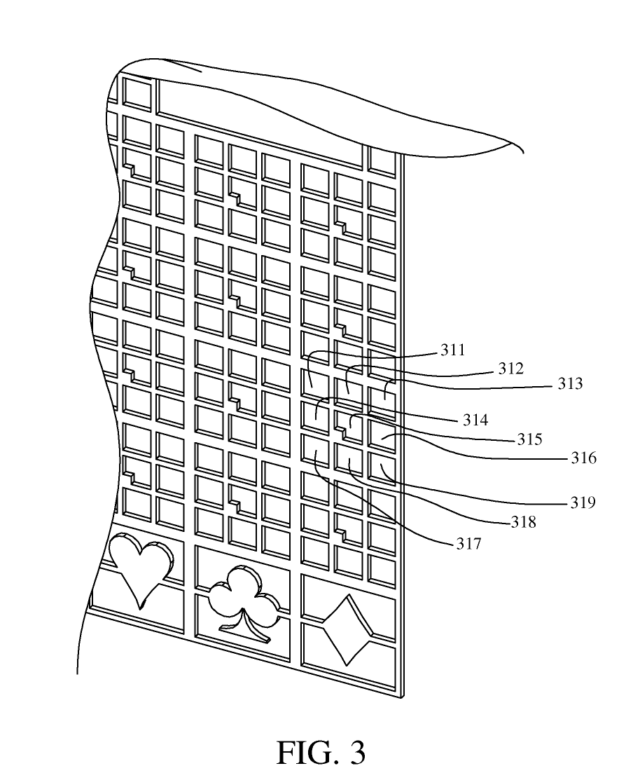

Please refer to FIGS. 2 and 3, in which a multi-coordinate orthodontic implant positioning device according to a first preferred embodiment of the present invention is shown. The multi-coordinate orthodontic implant positioning device includes a measuring reference member 10 that has, on the one hand, a predetermined thickness to possess sufficient strength for serving as a temporary support in the process of implanting an orthodontic implant and is, on the other hand, slim and light enough for disposing between a patient's two teeth at a cheek side or a tongue side thereof. On the measuring reference member 10, there is provided a plurality of measuring scales 11 formed of a radiopaque material. And, a fixing member 12 is connected to an edge of the measuring reference member 10 for fixedly attaching to the patient's teeth.

In the illustrated preferred embodiment, the fixing member 12 is made of a settable plastic material. By adjusting the fixing member 12, the orthodontic implant positioning device can be attached to a patient's gum between two adjacent teeth at the cheek side or the tongue side thereof for use as a measuring and positioning reference. After the orthodontic implant positioning device is fixed to a desired position, the fixing member 12 is allowed to set, so as to ensure that the fixing member 12 can always maintain the required positioning standard in the whole process of implant surgery.

The measuring scales 11 define a coordinate-type positioning structure 13, which includes at least a main coordinate system 20 and a sub-coordinate system 30. With the main coordinate system 20, the positioning structure 13 is divided into a plurality of coordinate blocks 21, each of which has a main coordinate code readable from the main coordinate system 20. The sub-coordinate system 30 is provided in some specified ones of the coordinate blocks 21. With the sub-coordinate system 30, more accurate positioning can be achieved in the specified coordinate blocks 21. To allow adjustment of the measuring reference member 10 within the patient's oral cavity, the measuring reference member 10 can be made of a flexible material.

In the illustrated first preferred embodiment, the main coordinate system 20 is a 4×4 Cartesian coordinate system to primarily divide the positioning structure 13 into sixteen coordinate blocks 21. However, it is understood the main coordinate system 20 with the above-described size and the above-mentioned number of coordinate blocks 21 is illustrated only for assisting in describing the present invention and not intended to limit the scope thereof. The size of the main coordinate system 20 and the number of the coordinate blocks 21 may be adjusted according to the size of the positioning structure 13. For a larger positioning structure 13, a larger main coordinate system 20 can be provided to include more coordinate blocks 21. On the other hand, for a smaller positioning structure 13, a smaller main coordinate system 20 is provided to avoid the coordinate blocks 21 thereof from each having a too small area. It is understood a coordinate system with too densely divided coordinate blocks would lose its utility.

The main coordinate system 20 includes a set of first coordinate axis marks 22 and a set of second coordinate axis marks 23 separately located at two adjacent edges of the positioning structure 13. For the purpose of conciseness, the first and the second coordinate axis marks 22, 23 are also collectively referred to as “the coordinate axis marks” herein. In the set of first coordinate axis marks 22, there are four sequentially arranged patterns, including a spade ( [symbol] ), a heart (♡), a club ( [symbol] ) and a diamond (♦); and in the set of second coordinate axis marks 23, there are four sequentially arranged Roman numerals, including I, II, III and V. Therefore, each of the coordinate blocks 21 has a unique main coordinate code corresponding thereto. Since the patterns or symbols used to represent the first coordinate axis marks 22 and the patterns or symbols used to represent the second coordinate axis marks 23 are chosen from different series of designs, it is able to avoid a user from confusing the first coordinate axis marks 22 with the second coordinate axis marks 23. Further, all the designs selected for use as the patterns or symbols to represent the coordinate axis marks are laterally symmetrical designs. By doing this, there is no risk of taking an x-ray picture with laterally reversed or hardly recognizable coordinate axis marks, no matter how the orthodontic implant positioning device is disposed in the patient's oral cavity.

In the coordinate blocks 21 divided according to the main coordinate system 20, the sub-coordinate system 30 is further provided to enable more accurate positioning. In the illustrated first preferred embodiment, the sub-coordinate system 30 is provided in each of the specified coordinate blocks 21. However, it is understood the first preferred embodiment is illustrated only for assisting in describing the present invention and not intended to limit the scope thereof. That is, in some coordinate blocks 21, it is not necessary to further provide the sub-coordinate system 30 for more accurate positioning. For example, for the coordinate blocks 21 that are to be located at or very close to the patient's roots of teeth, the sub-coordinate system 30 can be omitted to reduce the manufacturing cost of the multi-coordinate orthodontic implant positioning device. On the other hand, in the case more accurate positioning is required in the implanting of the orthodontic implant at a specific location, the coordinate block 21 corresponding to that location can have more than one sub-coordinate system 30 provided therein to enable highly accurate positioning.

An area in each of the coordinate blocks 21 is further divided by the sub-coordinate system 30 into a plurality of coordinate cells 31. A positioning mark 32 is provided in one of the coordinate cells 31 in the same one coordinate block 21 to serve as a reference point, enabling a user to conveniently determine the coordinates of a desired position. In the illustrated first preferred embodiment, the sub-coordinate system 30 is a 3×3 Cartesian coordinate system with a positioning point 321 provided in a middle one of nine coordinate cells 31 in the same one coordinate block 21 to serve as the positioning mark 32. Based on and relative to the positioning point 321, the nine coordinate cells 31 are separately named as upper-left coordinate cell 311, upper-middle coordinate cell 312, upper-right coordinate cell 313, left-middle coordinate cell 314, middle coordinate cell 315, right-middle coordinate cell 316, lower-left coordinate cell 317, lower-middle coordinate cell 318, and lower-right coordinate cell 319. With the positioning point 321 located in the middle coordinate cell 315 in each of the coordinate blocks 21, a user can easily determine whether a set of coordinate cells 31 being seen is located in the same one coordinate block 21.

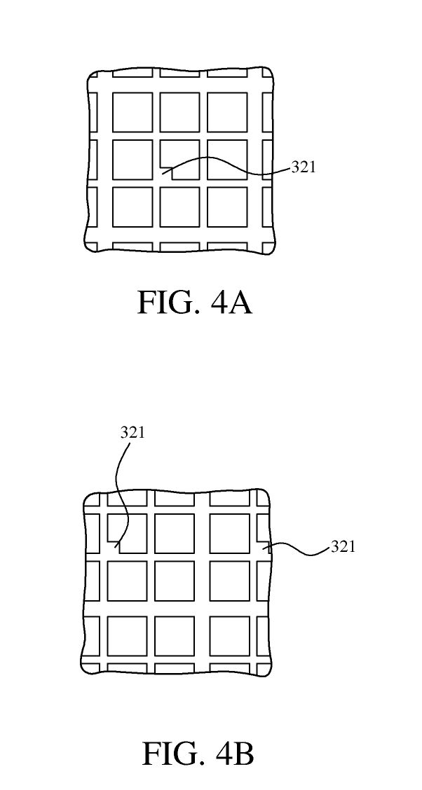

Please refer to FIGS. 4A and 4B. When a user sees the positioning point 321 is provided in a middle one of nine coordinate cells 31 being seen, the user can determine the nine coordinate cells 31 being seen are located in the same one coordinate block 21. On the other hand, when the positioning point 321 is not located in the middle one of nine coordinate cells 31 being seen but is located in a non-middle coordinate cell 31, the user can also determine the nine coordinate cells 31 being seen are located in at least two adjacent coordinate blocks 21. In this way, the user can positively find any error or deviation in implant position in the process of reading the x-ray picture taken with the aid of the multi-coordinate orthodontic implant positioning device of the present invention and corrects the error immediately. Thus, the accuracy in determining the implant position is increased. However, it is understood the illustrated 3×3 Cartesian sub-coordinate system 30 defining nine coordinate cells 31 is only an example for assisting in the description of the present invention and not intended to limit the scope thereof.

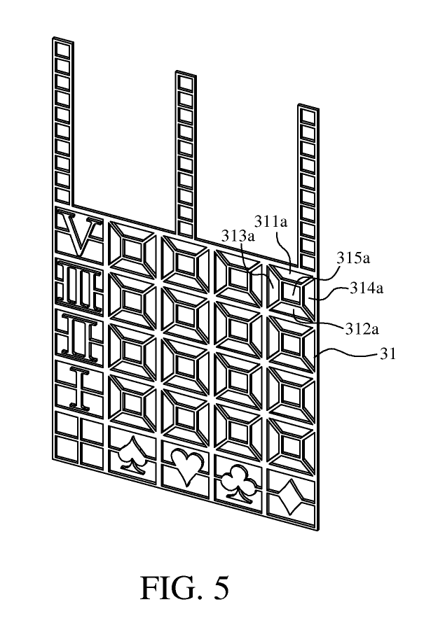

Please refer to FIG. 5 that shows another preferred embodiment of the present invention. In this embodiment, the sub-coordinate system 30 divides each of the specified coordinate blocks 21 into five coordinate cells 31, namely, upper coordinate cell 311a, lower coordinate cell 312a, left coordinate cell 313a, right coordinate cell 314a, and middle coordinate cell 315a. Due to the specific arrangement of the boundary lines in the sub-coordinate system 30, the five coordinate cells 31 in the second embodiment are different in their shapes. Further, the middle coordinate cell 315a overlaps a central area of the coordinate block 21. Since the five coordinate cells 31 respectively have a different shape, they are sufficient for providing the positioning function without the need of providing any additional positioning mark 32 in the sub-coordinate system 30.

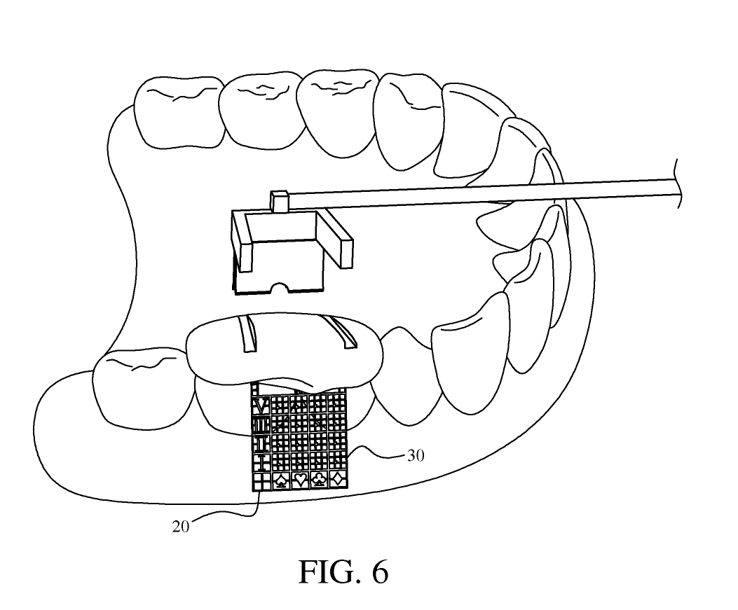

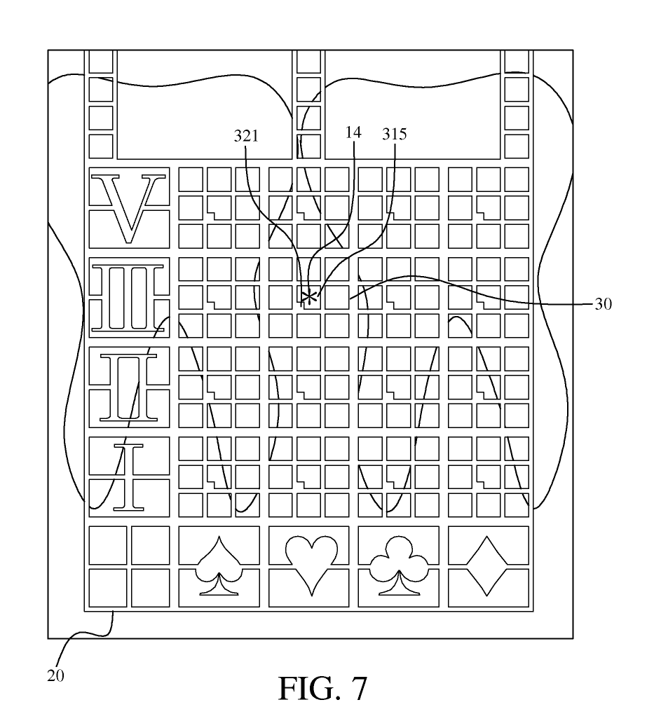

Please refer to FIGS. 6 and 7. In practical use of the multi-coordinate orthodontic implant positioning device of the present invention, first follow the general method of mounting an orthodontic implant positioning device to dispose the orthodontic implant positioning device of the present invention in the patient's oral cavity, and take an X-ray picture for measuring the patient's inter-teeth distance. Then, determine according to the x-ray picture an implant point 14 that is suitable for implanting the orthodontic implant. In the example illustrated in FIG. 7, the optimal implant point 14 is located at a position as marked by the symbol * in the x-ray picture. The exact position of the optimal implant point 14 can be determined with the main coordinate system 20 and the sub-coordinate system 30. That is, in the x-ray picture, the symbol * is located in a coordinate block 21 defined by the heart (♡) row and the III line of the main coordinate system 20, and is located at the middle coordinate cell 315 defined by the sub-coordinate system 30 in that coordinate block 21. Therefore, the optimal implant point 14 is recorded as (♡III, middle) or (♡) middle, III middle). By recording the implant point 14 using multiple coordinate systems, it not only enables more accurate determination of the position of the optimal implant point 14, but also provides dentists a simple and clear way for marking the implant point 14 when they discuss the implant point 14 in an orthodontic surgery.

In brief, on the multi-coordinate orthodontic implant positioning device of the present invention, a coordinate-type positioning structure is defined by the measuring scales, and a main coordinate system and a sub-coordinate system are included in the positioning structure for use at the same time. A user can conveniently and correctly mark the position of an optimal implant point by reading the main coordinate system and determining the coordinate block in which the optimal implant point is located, and then reading the sub-coordinate system to determine the coordinate cell in the coordinate block with the optimal implant point located therein.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A multi-coordinate orthodontic implant positioning device for disposing in a patient's oral cavity between two adjacent teeth at a cheek side or a tongue side thereof to serve as a measuring and positioning reference, comprising a measuring reference member; the measuring reference member, on the one hand, having a predetermined thickness to possess sufficient strength for serving as a temporary support in the process of implanting an orthodontic implant and, on the other hand, being slim and light enough for disposing at the cheek side or the tongue side of a patient's teeth; the measuring reference member being provided thereon with a plurality of measuring scales formed of a radiopaque material, and being connected at an edge to a fixing member for fixedly attaching to the patient's teeth; the measuring scales defining a coordinate-type positioning structure, which includes at least a main coordinate system and a sub-coordinate system; the main coordinate system dividing the positioning structure into a plurality of coordinate blocks, each of which has a main coordinate code readable from the main coordinate system; and the sub-coordinate system being provided in some specified ones of the coordinate blocks, so that more accurate positioning can be achieved in the specified coordinate blocks.

2. The multi-coordinate orthodontic implant positioning device as claimed in claim 1, wherein the main coordinate system is a Cartesian coordinate system to divide the measuring scales into a plurality of rectangular coordinate blocks.

3. The multi-coordinate orthodontic implant positioning device as claimed in claim 2, wherein the sub-coordinate system divides each of the specified coordinate blocks into a plurality of coordinate cells and provides at least one positioning mark in one of the coordinate cells.

4. The multi-coordinate orthodontic implant positioning device as claimed in claim 3, wherein the measuring reference member is provided at two adjacent edges respectively with a set of first coordinate axis marks and a set of second coordinate axis marks.

5. The multi-coordinate orthodontic implant positioning device as claimed in claim 4, wherein the first coordinate axis marks and the second coordinate axis marks are different marks selected from laterally symmetrical patterns or symbols.

6. The multi-coordinate orthodontic implant positioning device as claimed in claim 4, wherein the first coordinate axis marks are located at one edge of the measuring reference member opposite to the edge connected to the fixing member, and the second coordinate axis marks are located at one edge of the measuring reference member adjacent to the edge connected to the fixing member.

7. The multi-coordinate orthodontic implant positioning device as claimed in claim 3, wherein the main coordinate system is a Cartesian coordinate system defining at least 2×2 coordinate blocks.

8. The multi-coordinate orthodontic implant positioning device as claimed in claim 3, wherein the sub-coordinate system is a 3×3 Cartesian coordinate system dividing each of the specified coordinate blocks into nine identical coordinate cells and the positioning mark is located in a middle one of the nine coordinate cells.

9. The multi-coordinate orthodontic implant positioning device as claimed in claim 1, wherein the measuring reference member is made of a flexible material in order to be bendable in the patient's oral cavity.
